(19) United States
(12) Patent Application Publication
(10) Pub. No.: US 2013/0149201 A1
(43) Pub. Date: Jun. 13, 2013

(54) SPRAY CLEANER ACCESSORY FOR REACTOR COMPONENT CLEANING

(71) Applicant: Kim Van Berkel, Mountain View, CA (US)

(72) Inventor: Kim Van Berkel, Mountain View, CA (US)

(73) Assignee: Intermolecular, Inc., San Jose, CA (US)

(21) Appl. No.: 13/315,609

(22) Filed: Dec. 9, 2011

(51) Int. Cl. B08B 9/093; B01J 19/26

(52) U.S. Cl. 422/129; 134/166 R; 134/167 R

(57) ABSTRACT

A reactor assembly including a first block having an array of reactors defined therein and a second block having an array of nozzles. The array of nozzles extends from a surface of the second block, the array of nozzles substantially aligned with the array of reactors so that each reactor is associated with a corresponding nozzle extending into a processing region of each reactor in the array of reactors when the surface of the second block is placed on a surface of the first block. Each nozzle of the array of nozzles has a plurality of openings disposed over a surface of the nozzle for dispersing fluid into the corresponding reactor. The array of nozzles is in fluid communication with a fluid source through a network of channels defined within the second block.

### BACKGROUND

Cleaning operations are routinely performed during semiconductor processing. In the case of semiconductor tools designed for high throughput parallel processes, achieving a level of cleaning sufficient to prevent cross-contamination can be complex and time-consuming, due to the fact that tools of this nature may consist of multiple compartments or reactor arrays. An example of such a tool in the context of semiconductor wet processing is the Tempus F-20 tool from Intermolecular. In this case, a variety of tool components and surfaces are potentially exposed to process chemicals during processing—chemicals which can give rise to cross-contamination if not properly removed. Examples of tool components susceptible to contamination include, the so-called rinse head, reactor block, reactor cell sleeves, and overhead stirrer impellers. Current procedures used routinely for cleaning these reactor components are non-optimal for various reasons. In some instances, cleaning liquid is unable to be adequately applied to all potentially contaminated surfaces of the reactor components, e.g., dispensing a small volume of cleaning liquid may give incomplete rinsing of surfaces of reactor cells and/or stirrers. In other instances, the application of cleaning liquids may result in undesirable exposure of sensitive hardware components and materials to both cleaning liquid and contaminants, giving potential for cross-contamination between processes performed in the reactor assembly, and for accelerated wear and tear on equipment. An example in the case of the Tempus F-20 would be using the reactor's de-ionized water supply to intentionally over-fill the reactor cells and impellers from the bottom up (so-called “back-filling” of reactor cells and impellers). In addition, the current procedures used are commonly labor-intensive and/or time-consuming and can require disassembly and manual cleaning/drying of hardware components.

### SUMMARY

In some embodiments, a reactor assembly is provided. The reactor assembly includes a first block having an array of reactors defined therein and a second block having an array of nozzles. The array of nozzles extends from a surface of the second block, the array of nozzles being substantially aligned with the array of reactors so that each reactor is associated with a corresponding nozzle extending into a processing region of each reactor in the array of reactors when the surface of the second block is placed on a surface of the first block. Each nozzle of the array of nozzles has a plurality of openings disposed over a surface of the nozzle for dispensing fluid into the corresponding reactor. The array of nozzles is in fluid communication with a fluid source through a network of channels defined within the second block.

In some embodiments, a spray cleaner accessory is provided for a reactor assembly having an array of reactors. The spray cleaner accessory includes a flat plate and an array of nozzles extending from a surface of the flat plate. The plate has an upper surface and a lower surface and is mountable on the reactor assembly. The array of nozzles extends from the lower surface of the plate, with each nozzle of the array of nozzles having a plurality of openings disposed over a surface of the nozzle. Each nozzle is elongated for extension into a corresponding reactor in the array of reactors. Each nozzle is connected via a supply line to a fluid supply for spraying a fluid into the corresponding reactor for cleaning and/or drying.

In some embodiments, a method is provided for cleaning a reactor assembly having an array of reactors. A spray cleaner accessory is fabricated for attachment to the array of reactors, the accessory including a flat plate having an upper surface and a lower surface and an array of elongated nozzles coupled to the lower surface, with each nozzle having a plurality of openings disposed on an outer surface of the nozzle. The spray cleaner assembly is coupled to the reactor assembly with each nozzle in the array of nozzles extending into a corresponding reactor of the array of reactors. The spray cleaner accessory is coupled to a fluid supply via a supply line. Fluid is sprayed into each reactor via the corresponding nozzle for cleaning and drying the reactor assembly.

### BRIEF DESCRIPTION OF THE DRAWINGS

FIG. 1 illustrates a simplified schematic diagram providing an overview of the High-Productivity Combinatorial (HPC) screening process for use in evaluating materials, unit processes, and process sequences for the manufacturing of semiconductor devices in accordance with some embodiments.

FIG. 2 illustrates a flowchart of a general methodology for combinatorial process sequence integration that includes site-isolated processing and/or conventional processing in accordance with some embodiments.

FIG. 3 illustrates a schematic cross-sectional view of a reactor cell and impeller in accordance with some embodiments.

FIGS. 4A-4D illustrate schematic cross-sectional views of a spray cleaner attachment for cleaning and drying a reactor cell assembly in accordance with some embodiments.

### DETAILED DESCRIPTION

The following description is provided as an enabling teaching of the invention and its best, currently known embodiments. Those skilled in the relevant art will recognize that many changes can be made to the embodiments described, while still obtaining the beneficial results. It will also be apparent that some of the desired benefits of the embodiments described can be obtained by selecting some of the features of the embodiments without utilizing other features. Accordingly, those who work in the art will recognize that many modifications and adaptations to the embodiments described are possible and may even be desirable in certain circumstances, and are a part of the invention. Thus, the following description is provided as illustrative of the principles of the embodiments of the invention and not in limitation thereof, since the scope of the invention is defined by the claims.

It will be obvious, however, to one skilled in the art, that the embodiments described may be practiced without some or all of these specific details. In other instances, well known process operations have not been described in detail in order not to unnecessarily obscure the present invention.

The embodiments describe a method and apparatus for ensuring the reactors and any impeller assembly for the reactor module are properly cleaned between experiments to avoid cross-contamination. The cross-contamination may cause variability between reactors introduced through the lack of ability to completely clean the reactors. The current techniques of so-called “manual cleaning”, “tip dispense”, and “back-fill” are either too manually intensive or ineffective. The embodiments provide for a spray cleaner attachment that has a plurality of nozzles attached to a surface of a block. The block has a plurality of pre-drilled holes to direct a cleaning fluid such as de-ionized (DI) water to each of the nozzles from a supply. The nozzles extend into each reactor block when the surface of the block of the spray cleaner is placed on top of the reactor block. The nozzles are configured as elongated tubes having a plurality of openings defined along a length of the nozzles, as well as being disposed around a perimeter of the nozzles in some embodiments. The openings in the elongated tubes may be angled to direct the cleaning fluid at different or varied angles toward the side walls of the reactors in one embodiment. The spray cleaner is also configured to fit within an impeller shaft that may be inserted into the reactor blocks.

Semiconductor manufacturing typically includes a series of processing steps such as cleaning, surface preparation, deposition, patterning, etching, thermal annealing, and other related unit processing steps. The precise sequencing and integration of the unit processing steps enables the formation of functional devices meeting desired performance metrics such as efficiency, power production, and reliability.

As part of the discovery, optimization and qualification of each unit process, it is desirable to be able to (i) test different materials, (ii) test different processing conditions within each unit process module, (iii) test different sequencing and integration of processing modules within an integrated processing tool, (iv) test different sequencing of processing tools in executing different process sequence integration flows, and combinations thereof in the manufacture of devices such as integrated circuits. In particular, there is a need to be able to test (i) more than one material, (ii) more than one processing condition, (iii) more than one sequence of processing conditions, (iv) more than one process sequence integration flow, and combinations thereof, collectively known as “combinatorial process sequence integration,” on a single monolithic substrate without the need for consuming the equivalent number of monolithic substrates per materials, processing conditions, sequences of processing conditions, sequences of processes, and combinations thereof. This can greatly improve both the speed and reduce the costs associated with the discovery, implementation, optimization, and qualification of materials, processes, and process integration sequences required for manufacturing.

High Productivity Combinatorial (HPC) processing techniques have been successfully adapted to wet chemical processing such as etching and cleaning. HPC processing techniques have also been successfully adapted to deposition processes such as physical vapor deposition (PVD), atomic layer deposition (ALD), and chemical vapor deposition (CVD).

Systems and methods for HPC processing are described in U.S. Pat. No. 7,544,574, filed on Feb. 10, 2006; U.S. Pat. No. 7,824,935, filed on Jul. 2, 2008; U.S. Pat. No. 7,871,928, filed on May 4, 2009; U.S. Pat. No. 7,902,063, filed on Feb. 10, 2006; and U.S. Pat. No. 7,947,531, filed on Aug. 28, 2009 each of which is incorporated by reference herein. Systems and methods for HPC processing are further described in U.S. patent application Ser. No. 11/352,077, filed on Feb. 10, 2006; U.S. patent application Ser. No. 11/419,174, filed on May 18, 2006; U.S. patent application Ser. No. 11/674,132, filed on Feb. 12, 2007; and U.S. patent application Ser. No. 11/674,137, filed on Feb. 12, 2007. The aforementioned patent applications claim priority from provisional patent application 60/725,186 filed Oct. 11, 2005. Each of the aforementioned patent applications and the provisional patent application are incorporated by reference herein.

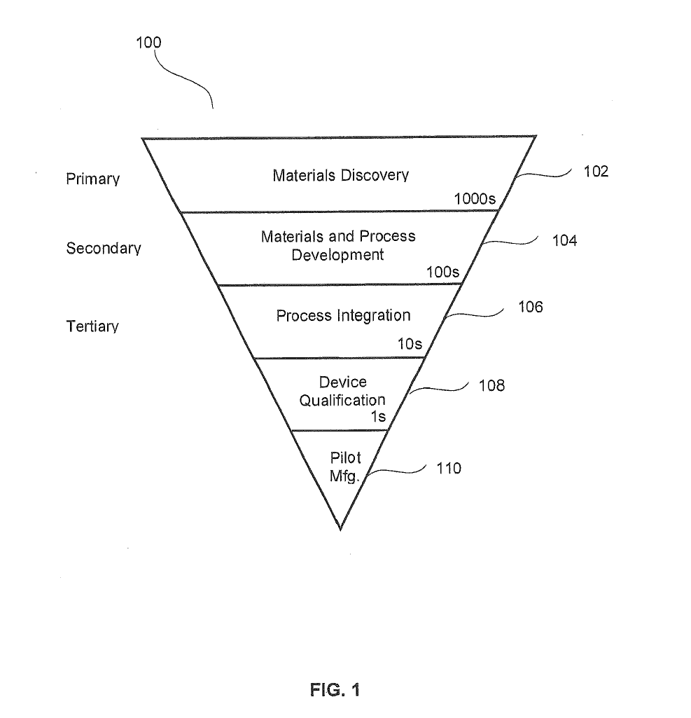

FIG. 1 illustrates a schematic diagram 100 for implementing combinatorial processing and evaluation using primary, secondary, and tertiary screening. The schematic diagram 100 illustrates that the relative number of combinatorial processes run with a group of substrates decreases as certain materials and/or processes are selected. Generally, combinatorial processing includes performing a large number of processes during a primary screen, selecting promising candidates from those processes, performing the selected processing during a secondary screen, selecting promising candidates from the secondary screen for a tertiary screen, and so on. In addition, feedback from later stages to earlier stages can be used to refine the success criteria and provide better screening results.

For example, thousands of materials are evaluated during a materials discovery stage 102. Materials discovery stage 102 is also known as a primary screening stage performed using primary screening techniques. Primary screening techniques may include dividing substrates into coupons and depositing materials using varied processes. The materials are then evaluated, and promising candidates are advanced to the secondary screen, or materials and process development stage 104. Evaluation of the materials is performed using metrology tools such as electronic testers and imaging tools (e.g., microscopes).

The materials and process development stage 104 may evaluate hundreds of materials (i.e., a magnitude smaller than the primary stage) and may focus on the processes used to deposit or develop those materials. Promising materials and processes are again selected, and advanced to the tertiary screen or process integration stage 106 where tens of materials and/or processes and combinations are evaluated. The tertiary screen or process integration stage 106 may focus on integrating the selected processes and materials with other processes and materials.

The most promising materials and processes from the tertiary screen are advanced to device qualification 108. In device qualification, the materials and processes selected are evaluated for high volume manufacturing, which normally is conducted on full substrates within production tools, but need not be conducted in such a manner. The results are evaluated to determine the efficacy of the selected materials and processes. If successful, the use of the screened materials and processes can proceed to pilot manufacturing 110.

The schematic diagram 100 is an example of various techniques that may be used to evaluate and select materials and processes for the development of new materials and processes. The descriptions of primary, secondary, etc. screening and the various stages 102-110 are arbitrary and the stages may overlap, occur out of sequence, be described and be performed in many other ways.

This application benefits from High Productivity Combinatorial (HPC) techniques described in U.S. patent application Ser. No. 11/674,137, filed on Feb. 12, 2007, which is hereby incorporated by reference in its entirety. Portions of the '137 application have been reproduced below to enhance the understanding of the embodiments disclosed herein. The embodiments disclosed enable the application of combinatorial techniques to process sequence integration in order to arrive at a globally optimal sequence of semiconductor manufacturing operations by considering interaction effects between the unit manufacturing operations, the process conditions used to effect such unit manufacturing operations, hardware details used during the processing, as well as material characteristics of components utilized within the unit manufacturing operations. Rather than only considering a series of local optimums, i.e., where the best conditions and materials for each manufacturing unit operation is considered in isolation, the embodiments described below consider effects of interactions introduced due to the multitude of processing operations that are performed and the order in which such multitude of processing operations are performed when fabricating a device. A global optimum sequence order is therefore derived, and as part of this derivation, the unit processes, unit process parameters, and materials used in the unit process operations of the optimum sequence order are also considered.

The embodiments described further analyze a portion or sub-set of the overall process sequence used to manufacture a semiconductor device. Once the subset of the process sequence is identified for analysis, combinatorial process sequence integration testing is performed to optimize the materials, unit processes, hardware details, and process sequence used to build that portion of the device or structure. During the processing of some embodiments described herein, structures are formed on the processed substrate that are equivalent to the structures formed during actual production of the semiconductor device. For example, such structures may include, but would not be limited to, contact layers, buffer layers, absorber layers, or any other series of layers or unit processes that create an intermediate structure found on semiconductor devices. While the combinatorial processing varies certain materials, unit processes, hardware details, or process sequences, the composition or thickness of the layers or structures or the action of the unit process, such as cleaning, surface preparation, deposition, surface treatment, etc. is substantially uniform throughout each discrete region. Furthermore, while different materials or unit processes may be used for corresponding layers or steps in the formation of a structure in different regions of the substrate during the combinatorial processing, the application of each layer or use of a given unit process is substantially consistent or uniform throughout the different regions in which it is intentionally applied. Thus, the processing is uniform within a region (inter-region uniformity) and between regions (intra-region uniformity), as desired. It should be noted that the process can be varied between regions, for example, where a thickness of a layer is varied or a material may be varied between the regions, etc., as desired by the design of the experiment.

The result is a series of regions on the substrate that contain structures or unit process sequences that have been uniformly applied within that region and, as applicable, across different regions. This process uniformity allows comparison of the properties within and across the different regions such that the variations in test results are due to the varied parameters (e.g., materials, unit processes, unit process parameters, hardware details, or process sequences) and not the lack of process uniformity. In the embodiments described herein, the positions of the discrete regions on the substrate can be defined as needed, but are preferably systematized for ease of tooling and design of experimentation. In addition, the number, variants and location of structures within each region are designed to enable valid statistical analysis of the test results within each region and across regions to be performed.

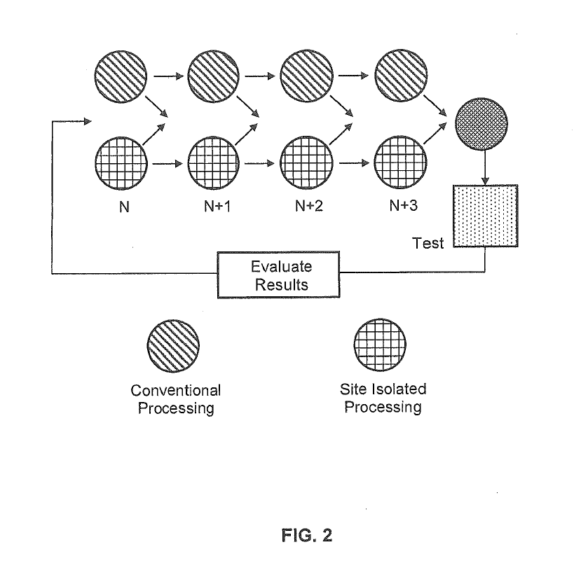

FIG. 2 is a simplified schematic diagram illustrating a general methodology for combinatorial process sequence integration that includes site isolated processing and/or conventional processing in accordance with one embodiment of the invention. In one embodiment, the substrate is initially processed using conventional process N. In one exemplary embodiment, the substrate is then processed using site isolated process N+1. During site isolated processing, an HPC module may be used, such as the HPC module described in U.S. patent application Ser. No. 11/352,077 filed on Feb. 10, 2006. The substrate can then be processed using site isolated process N+2, and thereafter processed using conventional process N+3. Testing is performed and the results are evaluated. The testing can include physical, chemical, acoustic, magnetic, electrical, optical, etc. tests. From this evaluation, a particular process from the various site isolated processes (e.g., from steps N+1 and N+2) may be selected and fixed so that additional combinatorial process sequence integration may be performed using site isolated processing for either process N or N+3. For example, a next process sequence can include processing the substrate using site isolated process N, conventional processing for processes N+1, N+2, and N+3, with testing performed thereafter.

It should be appreciated that various other combinations of conventional and combinatorial processes can be included in the processing sequence with regard to FIG. 2. That is, the combinatorial process sequence integration can be applied to any desired segments and/or portions of an overall process flow. Characterization, including physical, chemical, acoustic, magnetic, electrical, optical, etc. testing, can be performed after each process operation, and/or series of process operations within the process flow as desired. The feedback provided by the testing is used to select certain materials, processes, process conditions, and process sequences and eliminate others. Furthermore, the above flows can be applied to entire monolithic substrates, or portions of monolithic substrates such as coupons.

Under combinatorial processing operations the processing conditions at different regions can be controlled independently. Consequently, process material amounts, reactant species, processing temperatures, processing times, processing pressures, processing flow rates, processing powers, processing reagent compositions, the rates at which the reactions are quenched, deposition order of process materials, process sequence steps, hardware details, etc., can be varied from region to region on the substrate. Thus, for example, when exploring materials, a processing material delivered to a first and second region can be the same or different. If the processing material delivered to the first region is the same as the processing material delivered to the second region, this processing material can be offered to the first and second regions on the substrate at different concentrations. In addition, the material can be deposited under different processing parameters. Parameters which can be varied include, but are not limited to, process material amounts, reactant species, processing temperatures, processing times, processing pressures, processing flow rates, processing powers, processing reagent compositions, the rates at which the reactions are quenched, atmospheres in which the processes are conducted, an order in which materials are deposited, hardware details of the gas distribution assembly, etc. It should be appreciated that these process parameters are exemplary and not meant to be an exhaustive list as other process parameters commonly used in semiconductor manufacturing may be varied.

As mentioned above, within a region, the process conditions are substantially uniform, in contrast to gradient processing techniques which rely on the inherent non-uniformity of the material deposition. That is, the embodiments described herein perform the processing locally in a conventional manner, i.e., substantially consistent and substantially uniform, while globally over the substrate, the materials, processes, and process sequences may vary. Thus, the testing will find optimums without interference from process variation differences between processes that are meant to be the same. It should be appreciated that a region may be adjacent to another region in one embodiment or the regions may be isolated and, therefore, non-overlapping. When the regions are adjacent, there may be a slight overlap wherein the materials or precise process interactions are not known, however, a portion of the regions, normally at least 50% or more of the area, is uniform and all testing occurs within that region. Further, the potential overlap is only allowed with material of processes that will not adversely affect the result of the tests. Both types of regions are referred to herein as regions or discrete regions.

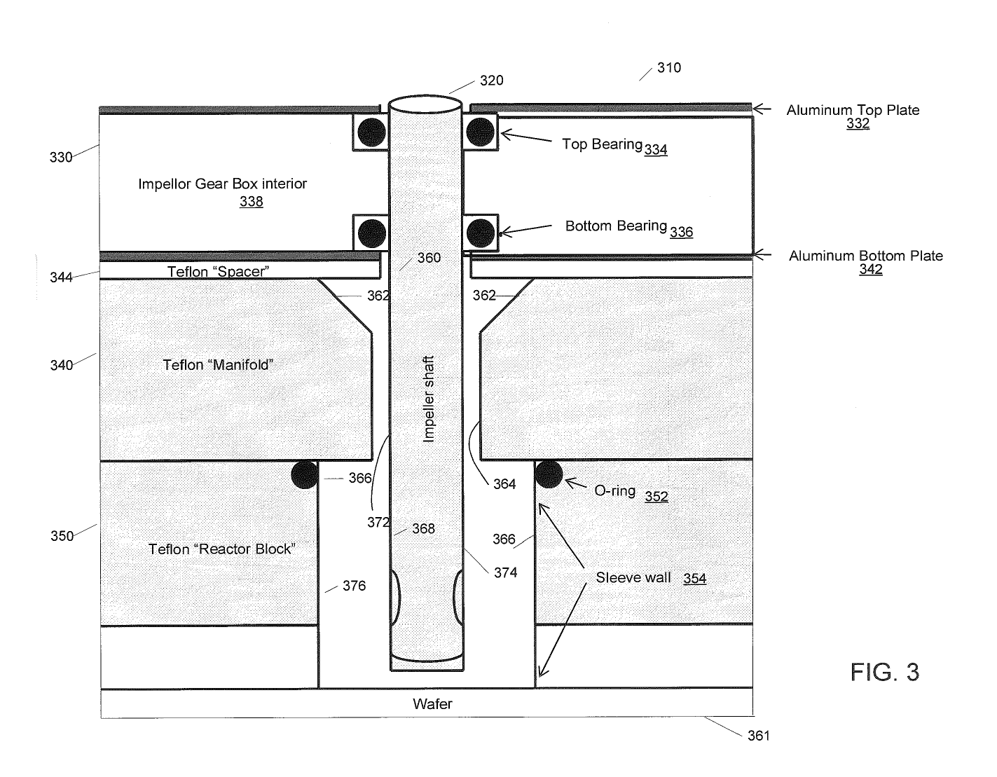

An exemplary reactor assembly includes a plurality of reactor cells, e.g., 18 or 32 cells in some embodiments. FIG. 3 illustrates a schematic view of a reactor cell and impeller cross-section. The reactor cell and impeller cross-section 310 for processing a wafer 360 includes a reactor block 350, a rinse head 340, an impeller shaft 320, and an impeller gear box 330. The impeller gear box 330 has an interior section 338 and interior bearings 334, 336 support a top plate 332 and a bottom plate 342, respectively. A spacer 344 separates the impeller gear box 330 and rinse head 340. Reactor block 350 includes a sleeve wall 354 and O-ring 352. Following an experiment in the reactor assembly, the impeller shaft is 320 likely to be contaminated along an upper interior portion 360 from near the top of impeller gear box 330 to midway through reactor block 350 since this portion comes into direct contact with the chemistry and is not touched by in-cell rinse water. The exterior of the impeller shaft 320 is potentially contaminated along exterior portion 372. The interior of the rinse head 340 and the sleeve wall 354 of reactor block 350 are potentially contaminated along portions 362, 364, and 366. The potential contamination depends on the process temperature, stir rate, chemistry type, etc., used in the experiment. The lower interior portion 368 of impeller shaft 320, the exterior portion 374 of impeller shaft 320, and the lower portion 376 of sleeve wall 354 are likely to have very low if any contamination remaining after an in-cell water rinse cycle through the apparatus described herein. It should be appreciated that the materials of composition for the reactor assembly may be any suitable material compatible with the chemicals utilized in the combinatorial processing and may include materials such as Polytetrafluoroethylene (PTFE), aluminum, etc. A discussion of some embodiments of the reactor details may be found in U.S. patent application Ser. No. 11/352,077 entitled “Methods for Discretized Processing and Process Sequence Integration of Regions of a Substrate”, filed on Feb. 10, 2006 and claiming priority to U.S. Provisional Patent Application No. 60/725,186 filed on Oct. 11, 2005, each of which are herein incorporated by reference.

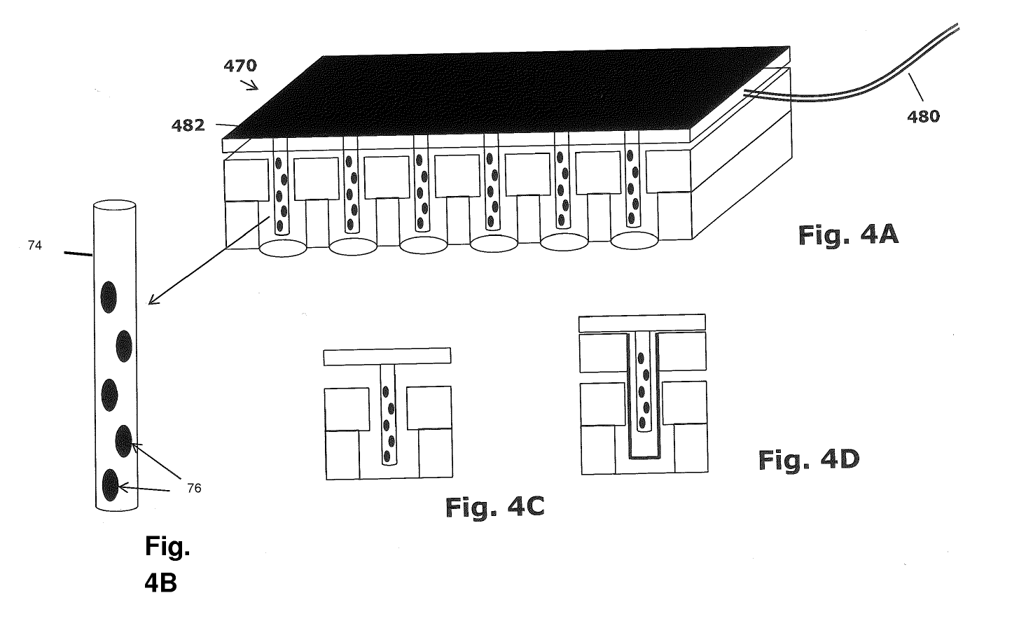

FIGS. 4A-4D illustrate schematic cross-sectional views of a spray cleaner accessory 470 for cleaning and drying a reactor cell assembly in an exemplary embodiment. In some embodiments depicted in FIG. 4A, a spray cleaner accessory 470 can be installed on the reactor assembly or overhead stirrer assembly to provide a flow of either cleaning liquid (e.g., water or organic solvent) or gas (e.g., nitrogen or CDA) to clean and/or dry the internal surfaces of these reactor components. In some embodiments, the spray cleaner accessory 470 can include a flat plate 482 made of PTFE or another appropriate rigid, chemically-resistant material. The plate 482 can be connected to a supply line 480 providing a flow of liquid or gas. The plate 482 can be cross-drilled internally allowing the flow of liquid or gas to the appropriate number of outlet positions on one of the plate's surfaces (e.g., 18 or 32 positions for an exemplary reactor set-up). A thin elongated nozzle 474, composed of a chemically-resistant material (e.g., Teflon, polypropylene, PFA) can protrude from each position on the plate 482. The nozzles 474 are drilled with orifices or openings 476 that permit the liquid or gas supplied to shower out of the nozzle 474 and spray onto the surrounding surfaces. The nozzles extend into each reactor cell when the surface of the plate 482 of the spray cleaner accessory 470 is placed on top of the reactor block. The diameter of each nozzle is less than the diameter of the reactor cell or impeller shaft into which the nozzle extends.

In an exemplary reactor cleaning application, the spray from the nozzles 474 can rinse contaminants from the inner surfaces of the respective reactor cells and/or overhead stirrer impellers. The openings 476 in the elongated nozzles, as illustrated in FIG. 4B, may be angled to direct the cleaning fluid at different angles toward the side walls of the reactors in some embodiments. FIG. 4C depicts the spray cleaner positioned within a reactor cell. The spray cleaner may also be configured to fit within an impeller shaft that may be inserted into the reactor blocks in some embodiments. FIG. 4D depicts the spray cleaner positioned within an impeller shaft in some embodiments.

In some embodiments, the spray nozzles 474 can be freely rotatable (e.g., mounted on a bearing), such that the nozzles 474 may be rotated during the spraying process, for example, by a motor-driven system, or simply by the pressure of the liquid/gas flowing through. Methods for drying the reactor assembly and overhead stirrer include: (1) rotating the overhead stirrer impellers at a high rate; (2) manually spraying nitrogen gas into each cell opening using a hand-held nitrogen gun; or (3) manually disassembling the reactor and overhead stirrer components and manually drying the disassembled components using towels or a hand-held nitrogen gun. Alternatively, the spray cleaner accessory described herein may be utilized to provide a flow of inert gas, or heated inert gas, into the reactor cells or impeller shafts for drying.

When compared to existing methods, the embodiments described can provide a flow of liquid or gas for cleaning and/or drying directly to all potentially contaminated hardware components, in a manner that provides less potential for damage or wear and tear to hardware components and/or that is more time-efficient and labor-saving. The embodiments provide a spray cleaning accessory with dimensions and a grid layout uniquely suited to spray cleaning of process equipment having a closely spaced array of small openings (e.g., reactor cells).

The corresponding structures, materials, acts, and equivalents of all means plus function elements in any claims below are intended to include any structure, material, or acts for performing the function in combination with other claim elements as specifically claimed.

Those skilled in the art will appreciate that many modifications to the exemplary embodiments are possible without departing from the spirit and scope of the present invention. In addition, it is possible to use some of the features of the present invention without the corresponding use of the other features. Accordingly, the foregoing description of the exemplary embodiments is provided for the purpose of illustrating the principles of the present invention, and not in limitation thereof, since the scope of the present invention is defined solely by the appended claims.

What is claimed:

1. A reactor assembly, comprising:
a first block having an array of reactors defined therein; and
a second block having an array of nozzles extending from a surface of the second block, the array of nozzles aligned with the array of reactors so that each of the nozzles extends into a processing region of the correspondingly aligned reactor when the surface of the second block is placed on a surface of the first block,
a plurality of openings disposed over a surface of each nozzle of the array of nozzles for dispersing fluid into the processing region of the reactor; and
a network of channels defined within the second block, the network of channels in fluid communication with a fluid source.

2. The reactor assembly of claim 1 wherein a diameter of each nozzle of the array of nozzles is one of; less than a diameter of each reactor of the array of reactors, or less than a diameter of each impeller shaft of an array of impellers.

3. The reactor assembly of claim 1 wherein each of the plurality of openings disposed over the surface of each nozzle directs fluid at different angles within a corresponding reactor.

4. The reactor assembly of claim 1 wherein each nozzle of the array of nozzles is configured to extend into an impeller shaft disposed within each reactor of the array of reactors.

5. The reactor assembly of claim 1 wherein each nozzle of the array of nozzles rotates.

6. The reactor assembly of claim 1 wherein the second block comprises a rigid, chemically-resistant material.

7. The reactor assembly of claim 1 further comprising:
a plurality of bearings, wherein each bearing couples a corresponding nozzle to a surface of the second block such that the nozzle is rotatable when the fluid is dispersed in the reactor.

8. The reactor assembly of claim 1 wherein each nozzle of the array of nozzles comprises an elongated chemically-resistant structure defined by a length and a diameter.

9. A spray cleaner accessory for a reactor assembly having an array of reactors defined therein, comprising:
a block having an upper surface and a lower surface and mountable on the reactor assembly;
an array of nozzles extending from the lower surface of the block,
a plurality of openings disposed over a surface of each nozzle, wherein each of the nozzles is elongated for extension into a corresponding reactor in the array of reactors; and
a fluid supply for spraying a fluid into the corresponding reactor, the fluid supply coupled to each nozzle.

10. The spray cleaner accessory of claim 9 wherein each of the plurality of openings disposed over the surface of the nozzle directs fluid at different angles within the corresponding reactor.

11. The spray cleaner accessory of claim 9 wherein each nozzle of the array of nozzles comprises an elongated chemically-resistant structure defined by a length and a diameter.

12. The spray cleaner accessory of claim 11 wherein the diameter of each nozzle is less than one of; a diameter of the corresponding reactor, or a diameter of a corresponding impeller shaft.

13. The spray cleaner accessory of claim 9 wherein the block comprises a rigid, chemically-resistant material.

14. The spray cleaner accessory of claim 9 wherein each nozzle is coupled to the lower surface of the block through a bearing such that each nozzle is rotatable when the fluid is sprayed into the reactor.

15. The spray cleaner accessory of claim 9 wherein each nozzle in the array of nozzles is configured to extend into an impeller shaft disposed within each reactor.
